(19) United States
(12) Patent Application Publication
(10) Pub. No.: US 2013/0103485 A1
(43) Pub. Date: Apr. 25, 2013

(54) METHOD AND SYSTEM FOR PROVIDING CONSUMERS WITH CONTROL OVER USAGE OF THE CONSUMER' S DATA AND REWARDS ASSOCIATED THEREWITH

(71) Applicant: Richard Postrel, Miami Beach, FL (US)

(72) Inventor: Richard Postrel, Miami Beach, FL (US)

(21) Appl. No.: 13/276,688

(22) Filed: Oct. 19, 2011

(51) Int. Cl. G06Q 30/02

(52) U.S. Cl. 705/14.36

(57) ABSTRACT

A method of and system for providing consumers with control of the use of the consumer's data and providing associated rewards. A data control server computer (DCSC) receives from a consumer computing device consumer data and an associated data control parameter that specifies a level of control granted over the usage of the associated consumer data. The DCSC utilizes the received consumer data in accordance with the specified level of control over the usage of the consumer data. The DCSC will provide rewards to the consumer as a function of the consumer data entered by the consumer and the level of control of the usage of the consumer data specified by the consumer, and/or based on the quantity of the consumer data entered by the consumer, and/or based on the level of control of the usage of the consumer data specified by the consumer.

### TECHNICAL FIELD

This invention relates to reward systems, and in particular to a system and method that provides consumers with the ability to supply personal data and control the use of that personal data, as well as obtain rewards in exchange for providing such personal data.

### BACKGROUND OF THE INVENTION

The collection, aggregation, and analysis of consumer data is a large and continuously growing business. Many enterprises place great value on being able to obtain consumer data, including personal information such as income, medical, shopping habits and the like, as well as publicly available information such as address, telephone number, etc. This consumer data may have value on an individual basis as well as in the aggregate. Consumer data is often gathered by specialized companies and then analyzed and sold to marketing companies to enable them to better market products and services.

Consumers are usually hesitant to provide their personal data for several reasons. One major reason for concern by consumers is that they usually do not have any control over the usage of that data. Although a consumer may be willing to disclose his income to a company with whom he is contemplating a financial transaction, that consumer may only do so if he has assurances that the income information will not be made publicly available. Similarly, a consumer may be willing to provide his email address when registering with a certain web site, but the consumer is hesitant since he knows that the email address may be sold to another company and put on a mailing list that would cause the consumer to then receive countless spam email messages. Moreover, there are no incentive systems in place that would reward a consumer for supplying the requested consumer data. Therefore, the risks in providing consumer data far outweigh any benefits that the consumer may currently derive.

### SUMMARY OF THE INVENTION

Accordingly, provided is a computer-implemented method of and computer system for providing consumers with control of the use of the consumer's data and providing associated rewards for use of that data. The computer system includes a data control server computer; and at least one consumer computing device interconnected with the data control server computer. The data control server computer is programmed to receive from the consumer computing device (i) consumer data and (ii) a data control parameter associated with the consumer data, the data control parameter specifying a level of control granted over the usage of the associated consumer data. The data control server computer utilizes the received consumer data in accordance with the level of control over the usage of the consumer data specified by the associated data control parameter. The data control server computer will provide rewards to the consumer as a function of the consumer data entered by the consumer and the level of control of the usage of the consumer data specified by the consumer. In one embodiment, for example, the data control server computer is programmed to provide the consumer computing device with a data request form web page that includes at least one consumer data input field and an associated data usage control. The consumer data input field enables the consumer to enter requested consumer data, and the associated data usage control enables the consumer to enter a data control parameter specifying a level of control over the usage of consumer data entered into the consumer data input field.

The data control server computer may provide rewards to the consumer based on the quantity of the consumer data entered by the consumer, and/or based on the level of control of the usage of the consumer data specified by the consumer. For example, the rewards may include reward points added to a reward account associated with the user, and/or the rewards may include cash consideration or the like. In one embodiment, the rewards may be provided to the consumer as a function of a value ascribed to the consumer data when utilized in accordance with the level of control over the usage of the consumer data specified by the associated data control parameter.

The data control server computer may be programmed to store a consumer profile, which includes a plurality of consumer data and a data control parameter(s) associated with the plurality of consumer data. The data control server in this embodiment would also enable the consumer profile to be modified by the consumer by changing the consumer data or the data control parameter.

In an alternative embodiment, the data control server computer may be programmed to receive from each of a plurality of consumer computing devices (i) consumer data and (ii) a data control parameter associated with the consumer data, and then to aggregate the consumer data received from each of the plurality of consumer computing devices in accordance with the associated data control parameters to generate aggregated consumer data. The data control server may then utilize the aggregated consumer data and provide rewards to each of the plurality of consumers from whom consumer data has been received in accordance with the relative value of the consumer data with respect to the aggregated consumer data.

The data control server computer may optionally provide the received consumer data to a third party in accordance with the associated data control parameter. In this case, the data control server may then receive consideration from the third party based on the utilization by the third party of the consumer data in accordance with the associated data control parameter. The data control server would then provide rewards to the consumer as a function of the consideration received from the third party.

In another aspect of the invention, the data control server computer is programmed to receive from the consumer computing device authorization to acquire tracking data from the consumer computing device, wherein the tracking data is indicative of computing activity undertaken on the consumer computing device. Once authorized, the data control server will acquire tracking data from the consumer computing device and utilize the acquired tracking data. The data control server would then provide rewards to the consumer as a function of the acquired tracking data. For example, the computing activity undertaken on the consumer computing device may include web browsing activity. The data control server computer may also receive from the consumer computing device a data control parameter specifying a level of control granted over the usage of the acquired tracking data. In this case, the rewards are provided to the consumer as a function of the data control parameter.

In another aspect of the invention the data control server computer is programmed to receive from the consumer computing device (i) a consumer data retrieval permission parameter and (ii) an associated data control parameter. The consumer data retrieval permission parameter specifies permission to retrieve previously supplied consumer data, and the associated data control parameter specifies a level of control over the usage of previously supplied consumer data retrieved with permission from the consumer. The data control server computer then retrieves the previously supplied consumer data with permission from the consumer and utilizes the retrieved previously supplied consumer data in accordance with the level of control over the usage of the previously supplied consumer data specified by the associated data control parameter. Rewards are then provided by the data control server computer to the consumer as a function of the retrieved previously supplied consumer data and the level of control of the usage of the previously supplied consumer data specified by the consumer. The data control server computer may be programmed to provide rewards to the consumer based on the quantity of previously supplied consumer data for which permission to retrieve has been granted by the consumer to the data control server computer and/or the permission granted by the consumer to retrieve the previously supplied consumer data. In another aspect of the invention, a computer-implemented method of and system for rewarding a consumer for providing consumer data includes a data control server computer collecting consumer data associated with a consumer, the data control server computer utilizing the collected consumer data, and the data control server computer providing rewards to the consumer as a function of the utilization of the collected consumer data. The data control server computer collects consumer data associated with a consumer by receiving information input by consumer, and/or by requesting permission from the consumer to retrieve consumer data from an external source and if permission is granted by the consumer then retrieving consumer data from the external source. The rewards may be provided by the data control server computer to the consumer based the quantity of consumer data provided by the consumer, and/or based on the quality of consumer data provided by the consumer, and/or based on the permission to use the consumer data provided by the consumer. The rewards may include reward points added to a reward account associated with the user.

### BRIEF DESCRIPTION OF THE DRAWING

FIG. 1 is a block diagram of the system of the preferred embodiment of the present invention.

FIG. 2 is a flowchart of the operation of the present invention.

FIG. 3 illustrates an exemplary web page that is used in the present invention.

### DESCRIPTION OF THE PREFERRED EMBODIMENTS

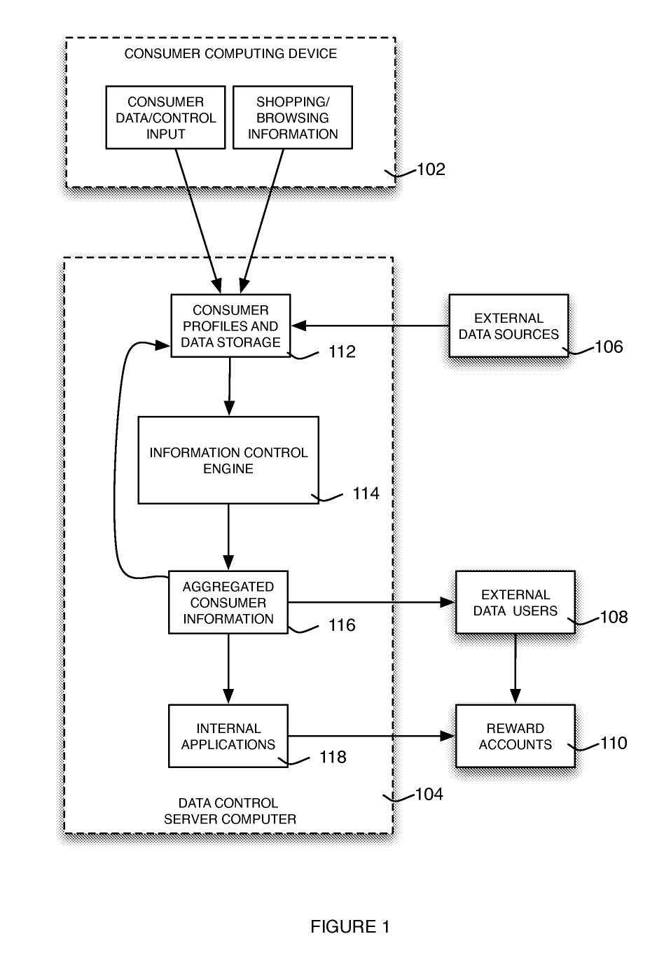

The preferred embodiments of the present invention will now be described in full detail with respect to the drawing figures. FIG. 1 is a block diagram of an exemplary system of the preferred embodiment of the present invention. The main components are a consumer computing device 102 and a data control server computer 104, which interconnect for communications via any of know mechanisms such as a network connection.

The consumer computing device 102 may be any type of computer or computing device that enables the consumer to perform data input and output functions as well as communicate with the data control server computer 104. For example, the consumer computing device 102 may be a desktop computer, a notebook or laptop computer, a handheld device such as a smartphone (e.g. IPHONE or ANDROID-based device), a tablet computer (such as an IPAD device), and interactive television, etc. These devices are well known in the art and need not be discussed in detail herein, except as to their specific interactions with the data control server computer 104 and the consumer operation. The data control server computer 104 may be any type of computer that can execute server or other type of software suitable for interacting with various consumer computing device 102. For example, a typical scenario would be the data control server computer 104 executing web server software that interacts with a web browser program executing on a consumer computing device 102 as well known in the art. In addition to web server/browser combinations, dedicated software clients may be used such as an application (app) that executes on a mobile consumer computing device 102. The data control server computer 104 also executes software modules that will be described in detail herein in order to carry out the functionalities of the preferred embodiment of the present invention.

Typically the network (not shown) will be a wide area network such as the Internet, but other types of networks and combinations of networks may be used in accordance with the invention. For example, it is contemplated that the interconnection between the consumer computing device 102 and the data control server computer 104 may be a combination of a wireless network and the Internet in the case where the consumer computing device 102 is a wireless device such as an IPHONE.

Also shown in FIG. 1 are external data sources 106, which as described below will include source of consumer data that are external to the data control server computer 104 such as data aggregators and data information companies. External data users 108 are also shown, which are entities that may purchase data (with consumer permission as described herein) from the data control server computer 104, such as product marketing services. These entities may in some cases be the same as the external data sources 106. Reward accounts 110 are also shown, which are accounts stored on external servers on behalf of the consumer as well known in the art. These may include for example AMERICAN EXPRESS MEMBERSHIP REWARDS, HILTON HHONORS, AMERICAN AADVANTAGE, etc. The data control server computer 104 may also store a reward account on behalf of the consumer that may be used with the present invention as will be further described herein.

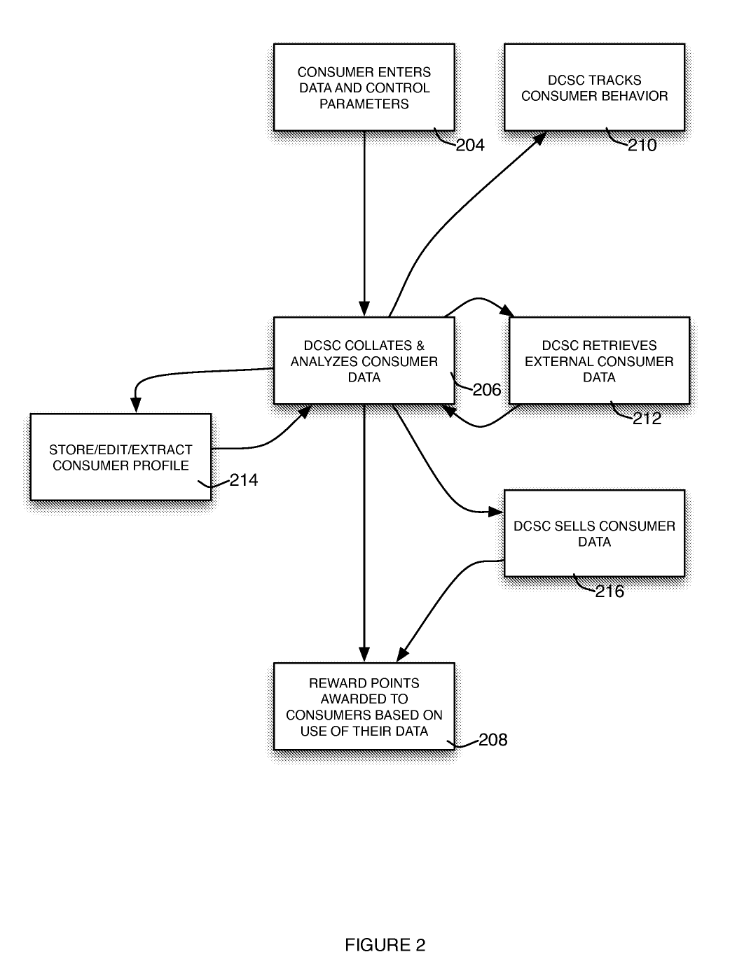

An overall process flow of the preferred embodiment of the present invention is shown in FIG. 2. At step 204, a consumer operating a consumer computing device 102 will enter consumer data as well as data control parameters, which will specify a level of control as to how the associated consumer data may be used by the data control server computer 104. For example, the consumer may enter his or her annual income, and specify an intermediate level of control which may be defined as allowing the data control server computer 104 to utilize that information in an anonymous aggregation with other consumers' data but not to link that data to that particular consumer. This will be described in further detail below. At step 206 the data control server computer 104 will utilize the consumer data received from the consumer computing device 102 in accordance with the level of control specified by the associated data control parameter. This utilization may for example include aggregation with similar data from other consumers. At step 208, rewards may be provided by the data control server computer 104 as a function of the utilization of the consumer data and the control level specified by the consumer. For example, the data control server computer 104 may award a consumer with 100 reward points into a reward account stored at the data control server computer 104 when the consumer provides his annual income but only allows the data control server computer 104 to aggregate that information with similar data from other consumers. If the consumer specifies that the data control server computer 104 may use that information in a more robust manner, such as by selling it to a third party for marketing purposes at step 216, then that consumer may receive more reward points (e.g. 500 points). Other means for awarding reward points are discussed further herein. Additionally, the reward points may be added to a reward account held by a third party on behalf of the consumer as further explained herein.

In some cases, the consumer may provide the data control server computer 104 with permission to track and monitor consumer behavior at step 210, such as while using the consumer computing device 102. The consumer would provide authorization via the consumer computing device 102 to the data control server computer 104 to acquire tracking data from the consumer computing device 102 that is indicative of computing activity undertaken on the consumer computing device 102. This computing activity may include, for example, web browsing activity as indicated by various mechanisms well known in the art such as history files, cookies, and other browser tracking techniques. When the consumer provides such tracking authorization to the data control server computer 104, he may also provide a data control parameter that specifies how the data control server computer 104 may utilize the tracking information. For example, the data control server computer 104 may only be able to use the consumer's browser history in the aggregate with the browsing history of other consumers, or the data control server computer 104 may be able to target product marketing campaigns to that user based on his browsing or shopping history if allowed by the consumer. Rewards are then also provided at step 208 as described above.

In another embodiment, the consumer computing device 102 may provide the data control server computer 104 with a consumer data retrieval permission parameter and an associated data control parameter. The consumer data retrieval permission parameter specifies permission for the data control server computer 104 to retrieve previously supplied consumer data, and the associated data control parameter specifies a level of control over the usage of previously supplied consumer data retrieved with permission from the consumer. For example, the consumer data retrieval permission parameter may permit the data control server computer 104 to retrieve data from an external source (step 212) that relates to the consumer, such as data previously collected by a third party or external data source 106. Once the data control server computer 104 has retrieved the consumer data from the external data source 106, then the data control server computer 104 may utilize that retrieved data in accordance with the level of control over the usage of the previously supplied consumer data that is specified by the associated data control parameter. As in the prior embodiments, the data control server computer 104 will then provide rewards to a consumer reward account at step 108.

The present invention may utilize any or all of the above-described techniques—data input by the consumer, data tracked on the consumer computing device 102, and/or data retrieved from external data sources—all as controlled by the consumer, in order to provide rewards to the consumer based on various parameters that will be described in further detail below.

The consumer data and associated control parameters may also be stored in a consumer profile at step 214, which may be updated as additional data is received from, tracked, or retrieved by the data control server computer 104 as set forth above. The data and/or permissions granted on the use of that data may also be modified by the consumer if desired by accessing the consumer's profile that is stored at the data control server computer 104. This provides the consumer with full control over the use of his or her data at any time desired.

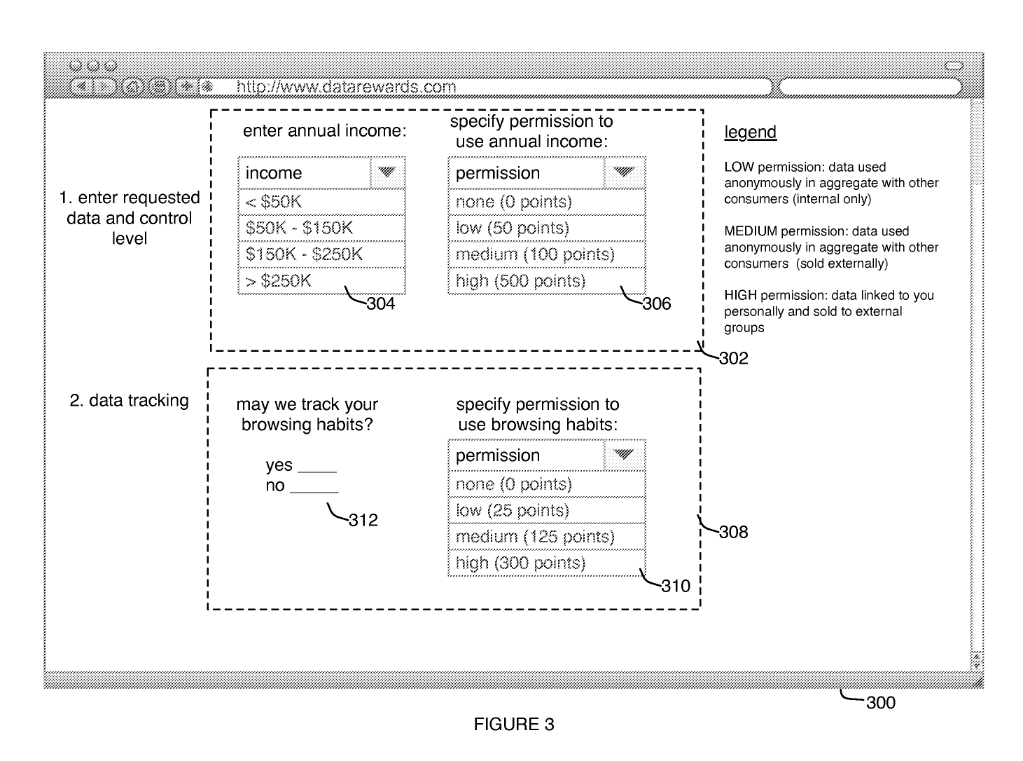

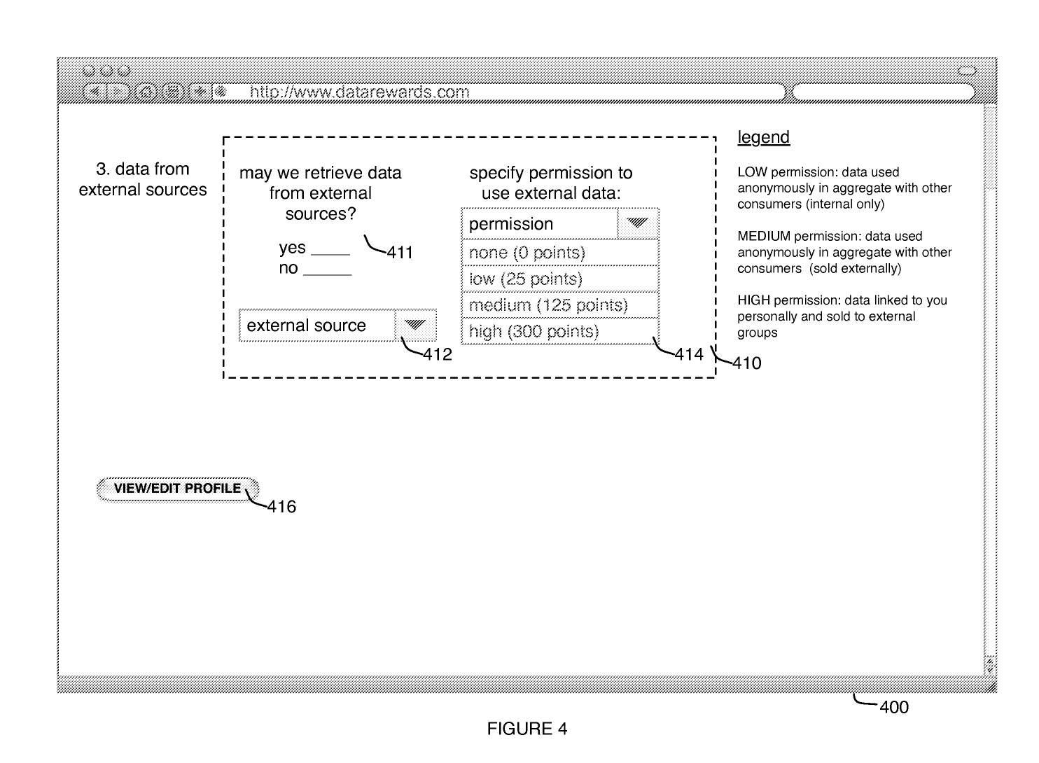

FIG. 3 illustrates an exemplary data request web form page 300 that is used in the present invention to enable the consumer to enter consumer data and an associated data control parameter that specifies a level of control over the usage of that data. Data entry box 302 provides a consumer data input field 304 enables the consumer to enter certain requested consumer data. In this example, the consumer is requested to enter his annual income by selecting a choice from the drop down menu (or, a text entry box could be provided to enable the consumer to enter an exact amount). A data usage control 306 is also provided, which in this example allows the consumer to specify the level of control over the usage of the annual income data he has entered, which is a drop down list of permissions (none, low, medium, and high). Also shown next to each permission level is the amount of reward points that the consumer will receive for usage of the data entered at the permission level granted. A legend is provided to inform the user of the specific permission parameters. For example, if the consumer grants low permission, his annual income data will be used anonymously in the aggregate with other consumers' input data. This may occur when the data control server computer 104 aggregates all income data and determines, for example, that 25% of the consumers earn between $50K and $150K, 75% earn between $150K and $250K, and 25% earn over $250K. This usage level provides only 50 reward points since there is not a lot of information being conveyed. However, if the consumer grants high permission, then he will receive 500 reward points for use of his income data. However, this will provide that the data is not anonymous and is linked to him personally, and will be provided to external sources such as marketing firms. This makes the data more valuable, and thus the increased reward level. Many other types of data besides income level may be requested from a consumer, which he can either not provide or provide along with a usage control level as described.

Also shown in FIG. 3 is a data tracking entry box 308, which has a data tracking authorization control 310. In this example, the consumer is asked for permission to allow the data control server computer 104 to track his web browsing habits. A data usage control 310 is also provided, which in this example allows the consumer to specify the level of control over the usage of the web browsing history being tracked, which is a drop down list of permissions (none, low, medium, and high). Also shown next to each permission level is the amount of reward points that the consumer will receive for usage of the tracked web browsing history at the permission level granted.

FIG. 4 illustrates a second data request web form page 400, which provides a consumer data retrieval permission parameter, which is a request to the consumer to allow the data control server computer 104 to retrieve and use consumer data from an external source(s). If the consumer answers yes, then he can optionally select which external source(s) may be used by the data control server computer 104 by using the external source drop down list 412. Data usage control 414 is also provided, which in this example allows the consumer to specify the level of control over the usage of the external data being retrieved by the data control server computer 104, which is a drop down list of permissions (none, low, medium, and high). Thus, for example, the consumer may allow the data control server computer 104 to retrieve his data from a certain third party external data source indicated in the drop down list 412, and then specify that the data control server computer 104 has only low permission for that external data, for which he would receive 25 points in his reward account.

As can be seen from the examples above, rewards may be provided to the consumer based on the quantity of the consumer data entered by the consumer. That is, the more data the consumer provides, then the more reward points he will receive. As can also be seen, rewards may be provided to the consumer based on the level of control over the usage of the consumer data specified by the consumer. The more control the consumer keeps (i.e. the lower permission level), then the lower amount of points are awarded. Conversely, when the consumer gives higher permission levels to use his data, then he will receive more reward points in exchange.

As explained above, reward points may be added to a reward account established at the data control server computer 104 on behalf of the user. In an alternative embodiment, the reward account may be an externally located account, such as the consumer's AMERICAN EXPRESS MEMBERSHIP REWARDS account.

In this embodiment, the data control server computer 104 will interact with the server computer that stores the external reward account, and request that reward points be added to his account when consumer data is used as described above. The data control server computer 104 will also likely be required to convey consideration to the external reward server (i.e. buy points) to compensate for the additional reward points added to the consumer's account. In addition to reward points, other types of rewards may be given to the consumer, including cash consideration.

As explained above, a consumer profile may be maintained at the data control server computer 104, which contains consumer data records for each consumer using the system. The consumer data records will contain the consumer data that has been entered (or tracked or retrieved), along with the associated data control parameters specified by the consumer for each piece of consumer data. This profile enables the data control server computer 104 to use various pieces of consumer data as required, without having to request new data and permission from the consumer each time it needs to assemble certain data. The consumer may view and edit his profile at any time by simply logging into the data control server computer 104 via his web browser and selecting a view/edit profile option control 416.

In one embodiment, the rewards provided to the consumer are a function of a value ascribed to the consumer data when utilized in accordance with the level of control over the usage of the consumer data specified by the associated data control parameter. For example, the data control server computer 104 may assemble consumer data from multiple consumers and sell the aggregated data to an external source (assuming the level of control specified by each consumer allows this). The external source would pay a price to the data control server computer 104 for that aggregated data, and the data control server computer 104 would then calculate the relative percentage of value contributed by each consumer towards the aggregated data and corresponding value. Then that ascribed value is used as a basis for awarding reward points to each consumer for their data. In a simple example, if 1,000 consumers provide their income data to the data control server computer 104, which in turn aggregates that data and sells it to an external source for $100, then each contributing consumer would get 1/1000 of that $100 which would be ten cents. As such, each consumer would receive ten cents worth of reward points into their reward account.

Referring back to FIG. 1, several modules are shown within the data control server computer 104 that are implemented to carry out the present invention. Consumer profiles and data storage 112 functions to store all consumer profiles, including consumer data that has been provided or retrieved from external data sources 106 as well as associated data control and permission data. Aggregated consumer information generated by module 116 may also be stored in this area. Information control engine 114 acts to process all stored data in accordance with control and permissions, and generate reward values to be provided to the consumers based on the usage of the data etc. Consumer data may be used by internal applications module 118, which may for example utilize the data for marketing and other purposes.

What is claimed is:

1. A computer-implemented method of providing consumers with control of the use of the consumer's data and providing associated rewards for use of that data comprising:
a. a data control server computer receiving from a consumer computing device (i) consumer data and (ii) a data control parameter associated with the consumer data, the data control parameter specifying a level of control granted over the usage of the associated consumer data;
b. the data control server computer utilizing the received consumer data in accordance with the level of control over the usage of the consumer data specified by the associated data control parameter, and
c. the data control server computer providing rewards to the consumer as a function of the consumer data received from the consumer computing device and the level of control of the usage of the consumer data.

2. The computer-implemented method of claim 1 comprising the further step of providing the consumer computing device with a data request form web page comprising a consumer data input field and an associated data usage control, the consumer data input field enabling the consumer to enter requested consumer data, the associated data usage control enabling the consumer to enter the data control parameter specifying the level of control over the usage of the consumer data entered into the consumer data input field.

3. The computer-implemented method of claim 1 wherein the rewards are provided to the consumer based on the quantity of the consumer data entered by the consumer.

4. The computer-implemented method of claim 1 wherein the rewards are provided to the consumer based on the level of control over the usage of the consumer data specified by the consumer.

5. The computer-implemented method of claim 1 wherein the rewards comprise reward points added to a reward account associated with the user.

6. The computer-implemented method of claim 1 wherein the rewards comprise cash consideration.

7. The computer-implemented method of claim 1 comprising the further step of the data control server computer storing a consumer profile, the consumer profile comprising a plurality of consumer data and a data control parameter associated with the plurality of consumer data.

8. The computer-implemented method of claim 7 comprising the further step of the data control server computer enabling the consumer profile to be modified by changing the consumer data or the data control parameter.

9. The computer-implemented method of claim 1 wherein the rewards provided to the consumer are a function of a value ascribed to the consumer data when utilized in accordance with the level of control over the usage of the consumer data specified by the associated data control parameter.

10. The computer-implemented method of claim 1 further comprising the steps of
receiving from each of a plurality of consumer computing devices (i) consumer data and (ii) a data control parameter associated with the consumer data;
aggregating the consumer data received from each of the plurality of consumer computing devices in accordance with the associated data control parameters to generate aggregated consumer data,
utilizing the aggregated consumer data, and
providing rewards to each of the plurality of consumers from whom consumer data has been received in accordance with the relative value of the consumer data with respect to the aggregated consumer data.

11. The computer-implemented method of claim 1 further comprising the steps of
providing the received consumer data to a third party in accordance with the associated data control parameter,
receiving consideration from the third party based on the utilization by the third party of the consumer data in accordance with the associated data control parameter, and
providing rewards to the consumer as a function of the consideration received from the third party.

12. A computer-implemented method of providing consumers with control of the use of the consumer's data and providing associated rewards for use of that data comprising:
a. a data control server computer receiving authorization from a consumer computing device to acquire tracking data from the consumer computing device, the tracking data indicative of computing activity undertaken on the consumer computing device,
b. the data control server computer acquiring tracking data from the consumer computing device as authorized,
c. the data control server computer utilizing the acquired tracking data, and
d. the data control server computer providing rewards to the consumer as a function of the acquired tracking data.

13. The computer-implemented method of claim 12 wherein the computing activity undertaken on the consumer computing device comprises web browsing activity.

14. The computer-implemented method of claim 12 further comprising receiving from the consumer computing device a data control parameter specifying a level of control granted over the usage of the acquired tracking data.

15. The computer-implemented method of claim 14 wherein the rewards are provided to the consumer as a function of the data control parameter.

16. The computer-implemented method of claim 12 wherein the rewards comprise reward points added to a reward account associated with the user.

17. A computer-implemented method of providing consumers with control of the use of the consumer's data and providing associated rewards for use of that data comprising:
a. a data control server computer receiving from a consumer computing device (i) a consumer data retrieval permission parameter and (ii) an associated data control parameter, the consumer data retrieval permission parameter specifying permission to retrieve previously supplied consumer data, the associated data control parameter specifying a level of control over the usage of previously supplied consumer data retrieved with permission from the consumer;
b. the data control server computer retrieving the previously supplied consumer data with permission from the consumer;
c. the data control server computer utilizing the retrieved previously supplied consumer data in accordance with the level of control over the usage of the previously supplied consumer data specified by the associated data control parameter, and
d. the data control server computer providing rewards to the consumer as a function of the retrieved previously supplied consumer data and the level of control of the usage of the previously supplied consumer data specified by the consumer.

18. The computer-implemented method of claim 17 wherein the rewards are provided to the consumer based on the quantity of previously supplied consumer data for which permission to retrieve has been granted by the consumer to the data control server computer.

19. The computer-implemented method of claim 17 wherein the rewards are provided to the consumer based on the permission granted by the consumer to retrieve the previously supplied consumer data.

20. The computer-implemented method of claim 17 wherein the rewards comprise reward points added to a reward account associated with the user.

21. A computer-implemented method of a consumer controlling the use of the consumer's data and receiving associated rewards for use of that data comprising:
a consumer computing device providing consumer data to a data control server computer, and
the consumer computing device providing a data control parameter associated with the consumer data to the data control server computer, the data control parameter specifying a level of control granted over the usage of the associated consumer data and enabling the data control server computer to utilize the consumer data in accordance with the level of control over the usage of the consumer data specified by the associated data control parameter and provide rewards to the consumer as a function of the consumer data provided by the consumer computing device and the level of control of the usage of the consumer data.

22. The computer-implemented method of claim 21 further comprising receiving a data request form web page from the data control server computer, the data request form web page comprising a consumer data input field and an associated data usage control, the consumer data input field enabling the consumer to enter requested consumer data, the associated data usage control enabling the consumer to enter the data control parameter specifying the level of control over the usage of the consumer data entered into the consumer data input field.

23. The computer-implemented method of claim 21 further comprising the consumer computing device modifying a consumer profile stored on the data control server computer, the consumer profile comprising a plurality of consumer data and a data control parameter associated with the plurality of consumer data.

24. A computer-implemented method of a consumer controlling the use of the consumer's data and receiving associated rewards for use of that data comprising:
a. a consumer computing device providing to a data control server computer authorization to acquire tracking data from the consumer computing device, the tracking data indicative of computing activity undertaken on the consumer computing device, and
b. the consumer computing device providing to the data control server computer tracking data as authorized for utilization by the data control server computer and for providing rewards to the consumer as a function of the acquired tracking data.

25. The computer-implemented method of claim 12 wherein the computing activity undertaken on the consumer computing device comprises web browsing activity.

26. The computer-implemented method of claim 12 further comprising the consumer computing device providing to the data control server computer a data control parameter specifying a level of control granted over the usage of the acquired tracking data.

27. A computer-implemented method of a consumer controlling the use of the consumer's data and receiving associated rewards for use of that data comprising:
a consumer computing device providing to a data control server computer a consumer data retrieval permission parameter specifying permission to retrieve previously supplied consumer data; and
the consumer computing device providing to the data control server computer an associated data control parameter, the associated data control parameter (i) specifying a level of control over the usage of previously supplied consumer data retrieved with permission from the consumer and (ii) enabling the data control server computer to utilize the retrieved previously supplied consumer data in accordance with the level of control over the usage of the previously supplied consumer data specified by the associated data control parameter and provide rewards to the consumer as a function of the retrieved previously supplied consumer data and the level of control of the usage of the previously supplied consumer data specified by the consumer.

28. A computer system for providing consumers with control of the use of the consumer's data and providing associated rewards comprising:
A. a data control server computer; and
B. a consumer computing device interconnected with the data control server computer; wherein the data control server computer is programmed to
a) receive from the consumer computing device (i) consumer data and (ii) a data control parameter associated with the consumer data, the data control parameter specifying a level of control granted over the usage of the associated consumer data;
b) utilize the received consumer data in accordance with the level of control over the usage of the consumer data specified by the associated data control parameter, and
c) provide rewards to the consumer as a function of the consumer data entered by the consumer and the level of control of the usage of the consumer data specified by the consumer.

29. The computer system of claim 28 wherein the data control server computer is programmed to provide the consumer computing device with a data request form web page comprising a consumer data input field and an associated data usage control, the consumer data input field enabling the consumer to enter requested consumer data, the associated data usage control enabling the consumer to enter a data control parameter specifying a level of control over the usage of consumer data entered into the consumer data input field.

30. The computer system of claim 28 wherein the data control server computer is programmed to provide rewards to the consumer based on the quantity of the consumer data entered by the consumer.

31. The computer system of claim 28 wherein the data control server computer is programmed to provide rewards to the consumer based on the level of control of the usage of the consumer data specified by the consumer.

32. The computer system of claim 28 wherein the rewards comprise reward points added to a reward account associated with the user.

33. The computer system of claim 28 wherein the rewards comprise cash consideration.

34. The computer system of claim 28 wherein the data control server computer is programmed to store a consumer profile, the consumer profile comprising a plurality of consumer data and a data control parameter associated with the plurality of consumer data.

35. The computer system of claim 34 wherein the data control server computer is programmed to enable the consumer profile to be modified by changing the consumer data or the data control parameter.

36. The computer system of claim 28 wherein the rewards provided to the consumer are a function of a value ascribed to the consumer data when utilized in accordance with the level of control over the usage of the consumer data specified by the associated data control parameter.

37. The computer system of claim 28 wherein the data control server computer is programmed to
receive from each of a plurality of consumer computing devices (i) consumer data and (ii) a data control parameter associated with the consumer data;
aggregate the consumer data received from each of the plurality of consumer computing devices in accordance with the associated data control parameters to generate aggregated consumer data,
utilize the aggregated consumer data, and
provide rewards to each of the plurality of consumers from whom consumer data has been received in accordance with the relative value of the consumer data with respect to the aggregated consumer data.

38. The computer system of claim 28 wherein the data control server computer is programmed to
provide the received consumer data to a third party in accordance with the associated data control parameter,
receive consideration from the third party based on the utilization by the third party of the consumer data in accordance with the associated data control parameter, and
provide rewards to the consumer as a function of the consideration received from the third party.

39. A computer system for providing consumers with control of the use of the consumer's data and providing associated rewards comprising:
A. a data control server computer; and
B. a consumer computing device interconnected with the data control server computer; wherein the data control server computer is programmed to
a. receive from the consumer computing device authorization to acquire tracking data from the consumer computing device, the tracking data indicative of computing activity undertaken on the consumer computing device,
b. acquire tracking data from the consumer computing device as authorized,
c. utilize the acquired tracking data, and
d. provide rewards to the consumer as a function of the acquired tracking data.

40. The computer system of claim 39 wherein the computing activity undertaken on the consumer computing device comprises web browsing activity.

41. The computer system of claim 39 wherein the data control server computer is programmed to receive from the consumer computing device a data control parameter specifying a level of control granted over the usage of the acquired tracking data.

42. The computer system of claim 41 wherein the rewards are provided to the consumer as a function of the data control parameter.

43. The computer system of claim 39 wherein the rewards comprise reward points added to a reward account associated with the user.

44. A computer system for providing consumers with control of the use of the consumer's data and providing associated rewards comprising:
a. a data control server computer; and
b. a consumer computing device interconnected with the data control server computer; wherein the data control server computer is programmed to
i) receive from the consumer computing device (A) a consumer data retrieval permission parameter and (B) an associated data control parameter, the consumer data retrieval permission parameter specifying permission to retrieve previously supplied consumer data, the associated data control parameter specifying a level of control over the usage of previously supplied consumer data retrieved with permission from the consumer;
ii) retrieve the previously supplied consumer data with permission from the consumer;
iii) utilize the retrieved previously supplied consumer data in accordance with the level of control over the usage of the previously supplied consumer data specified by the associated data control parameter; and
iv) provide rewards to the consumer as a function of the retrieved previously supplied consumer data and the level of control of the usage of the previously supplied consumer data specified by the consumer.

45. The computer system of claim 44 wherein the data control server computer is programmed to provide rewards to the consumer based on the quantity of previously supplied consumer data for which permission to retrieve has been granted by the consumer to the data control server computer.

46. The computer system of claim 44 wherein the data control server computer is programmed to provide rewards to the consumer based on the permission granted by the consumer to retrieve the previously supplied consumer data.

47. The computer system of claim 44 wherein the rewards comprise reward points added to a reward account associated with the user.

48. A data control server computer for providing consumers with control of the use of the consumer's data and providing associated rewards, the data control server computer being programmed to
a) receive from a consumer computing device (i) consumer data and (ii) a data control parameter associated with the consumer data, the data control parameter specifying a level of control granted over the usage of the associated consumer data;
b) utilize the received consumer data in accordance with the level of control over the usage of the consumer data specified by the associated data control parameter, and
c) provide rewards to the consumer as a function of the consumer data entered by the consumer and the level of control of the usage of the consumer data specified by the consumer.

49. The data control server computer of claim 48 further programmed to provide the consumer computing device with a data request form web page comprising a consumer data input field and an associated data usage control, the consumer data input field enabling the consumer to enter requested consumer data, the associated data usage control enabling the consumer to enter a data control parameter specifying a level of control over the usage of consumer data entered into the consumer data input field.

50. The data control server computer of claim 48 further programmed to provide rewards to the consumer based on the quantity of the consumer data entered by the consumer.

51. The data control server computer of claim 48 further programmed to provide rewards to the consumer based on the level of control of the usage of the consumer data specified by the consumer.

52. The data control server computer of claim 48 wherein the rewards comprise reward points added to a reward account associated with the user.

53. The data control server computer of claim 48 wherein the rewards comprise cash consideration.

54. The data control server computer of claim 48 further programmed to store a consumer profile, the consumer profile comprising a plurality of consumer data and a data control parameter associated with the plurality of consumer data.

55. The data control server computer of claim 54 further programmed to enable the consumer profile to be modified by changing the consumer data or the data control parameter.

56. The data control server computer of claim 48 wherein the rewards provided to the consumer are a function of a value ascribed to the consumer data when utilized in accordance with the level of control over the usage of the consumer data specified by the associated data control parameter.

57. The data control server computer of claim 48 further programmed to
receive from each of a plurality of consumer computing devices (i) consumer data and (ii) a data control parameter associated with the consumer data;
aggregate the consumer data received from each of the plurality of consumer computing devices in accordance with the associated data control parameters to generate aggregated consumer data,
utilize the aggregated consumer data, and
provide rewards to each of the plurality of consumers from whom consumer data has been received in accordance with the relative value of the consumer data with respect to the aggregated consumer data.

58. The data control server computer of claim 48 further programmed to
provide the received consumer data to a third party in accordance with the associated data control parameter,
receive consideration from the third party based on the utilization by the third party of the consumer data in accordance with the associated data control parameter, and
provide rewards to the consumer as a function of the consideration received from the third party.

59. A data control server computer for providing consumers with control of the use of the consumer's data and providing associated rewards, the data control server computer being programmed to:
a. receive from a consumer computing device authorization to acquire tracking data from the consumer computing device, the tracking data indicative of computing activity undertaken on the consumer computing device,
b. acquire tracking data from the consumer computing device as authorized,
c. utilize the acquired tracking data, and
d. provide rewards to the consumer as a function of the acquired tracking data.

60. The data control server computer of claim 59 wherein the computing activity undertaken on the consumer computing device comprises web browsing activity.

61. The data control server computer of claim 59 further programmed to receive from the consumer computing device a data control parameter specifying a level of control granted over the usage of the acquired tracking data.

62. The data control server computer of claim 61 wherein the rewards are provided to the consumer as a function of the data control parameter.

63. The data control server computer of claim 59 wherein the rewards comprise reward points added to a reward account associated with the user.

64. A data control server computer for providing consumers with control of the use of the consumer's data and providing associated rewards, the data control server computer being programmed to:
i) receive from a consumer computing device (A) a consumer data retrieval permission parameter and (B) an associated data control parameter, the consumer data retrieval permission parameter specifying permission to retrieve previously supplied consumer data, the associated data control parameter specifying a level of control over the usage of previously supplied consumer data retrieved with permission from the consumer;
ii) retrieve the previously supplied consumer data with permission from the consumer;
iii) utilize the retrieved previously supplied consumer data in accordance with the level of control over the usage of the previously supplied consumer data specified by the associated data control parameter; and
iv) provide rewards to the consumer as a function of the retrieved previously supplied consumer data and the level of control of the usage of the previously supplied consumer data specified by the consumer.

65. The data control server computer of claim 64 further programmed to provide rewards to the consumer based on the quantity of previously supplied consumer data for which permission to retrieve has been granted by the consumer to the data control server computer.

66. The data control server computer of claim 64 further programmed to provide rewards to the consumer based on the permission granted by the consumer to retrieve the previously supplied consumer data.

67. The data control server computer of claim 64 wherein the rewards comprise reward points added to a reward account associated with the user.

68. A consumer computing device controlling of the use of the consumer's data and receiving associated rewards, the consumer computing device being programmed to
provide consumer data to a data control server computer, and
provide a data control parameter associated with the consumer data to the data control server computer, the data control parameter specifying a level of control granted over the usage of the associated consumer data and enabling the data control server computer to utilize the consumer data in accordance with the level of control over the usage of the consumer data specified by the associated data control parameter and provide rewards to the consumer as a function of the consumer data provided by the consumer computing device and the level of control of the usage of the consumer data.

69. The consumer computing device of claim 68 further programmed to receive from the data control server computer a data request form web page comprising a consumer data input field and an associated data usage control, the consumer data input field enabling the consumer to enter requested consumer data, the associated data usage control enabling the consumer to enter a data control parameter specifying a level of control over the usage of consumer data entered into the consumer data input field.

70. The consumer computing device of claim 68 further programmed to modify a consumer profile stored on the data control server computer, the consumer profile comprising a plurality of consumer data and a data control parameter associated with the plurality of consumer data.

71. A consumer computing device controlling of the use of the consumer's data and receiving associated rewards, the consumer computing device being programmed to
a. provide to a data control server computer authorization to acquire tracking data from the consumer computing device, the tracking data indicative of computing activity undertaken on the consumer computing device, and
b. provide to the data control server computer tracking data as authorized for utilization by the data control server computer and for providing rewards to the consumer as a function of the acquired tracking data.

72. The consumer computing device of claim 71 wherein the computing activity undertaken on the consumer computing device comprises web browsing activity.

73. The consumer computing device of claim 71 further programmed to provide to the data control server computer a data control parameter specifying a level of control granted over the usage of the acquired tracking data.

74. A consumer computing device controlling of the use of the consumer's data and receiving associated rewards, the consumer computing device being programmed to
provide to a data control server computer a consumer data retrieval permission parameter specifying permission to retrieve previously supplied consumer data, and
provide to the data control server computer an associated data control parameter, the associated data control parameter (i) specifying a level of control over the usage of previously supplied consumer data retrieved with permission from the consumer and (ii) enabling the data control server computer to utilize the retrieved previously supplied consumer data in accordance with the level of control over the usage of the previously supplied consumer data specified by the associated data control parameter and provide rewards to the consumer as a function of the retrieved previously supplied consumer data and the level of control of the usage of the previously supplied consumer data specified by the consumer.

75. A computer-implemented method of rewarding a consumer for providing consumer data comprising:
a. a data control server computer collecting consumer data associated with a consumer,
b. the data control server computer utilizing the collected consumer data, and
c. the data control server computer providing rewards to the consumer as a function of the utilization of the collected consumer data.

76. The computer-implemented method of claim 75 wherein the step of the data control server computer collecting consumer data associated with a consumer comprises the data control server computer receiving information input by consumer.

77. The computer-implemented method of claim 75 wherein the step of the data control server computer collecting consumer data associated with a consumer comprises
i. the data control server computer requesting permission from the consumer to retrieve consumer data from an external source,
ii. if permission is granted by the consumer, then the data control server computer retrieving consumer data from the external source.

78. The computer-implemented method of claim 75 wherein the rewards are provided by the data control server computer to the consumer based the quantity of consumer data provided by the consumer.

79. The computer-implemented method of claim 75 wherein the rewards are provided by the data control server computer to the consumer based on the quality of consumer data provided by the consumer.

80. The computer-implemented method of claim 75 wherein the rewards are provided by the data control server computer to the consumer based on the permission to use the consumer data provided by the consumer.

81. The computer-implemented method of claim 75 wherein the rewards comprise reward points added to a reward account associated with the user.

82. A computer system for providing consumers with control of the use of the consumer's data and providing associated rewards comprising:
a. a data control server computer; and
b. a consumer computing device interconnected with the data control server computer; wherein the data control server computer is programmed to
i) collect consumer data associated with a consumer,
ii) utilize the collected consumer data, and
iii) provide rewards to the consumer as a function of the utilization of the collected consumer data.

83. The computer system of claim 82 wherein the data control server computer is programmed to collect consumer data associated with a consumer by receiving information input by consumer.

84. The computer system of claim 82 wherein the data control server computer is programmed to collect consumer data associated with a consumer by
i. requesting permission from the consumer to retrieve consumer data from an external source,
ii. if permission is granted by the consumer, then retrieving consumer data from the external source.

85. The computer system of claim 82 wherein the data control server computer is programmed to provide rewards to the consumer based on the quantity of consumer data provided by the consumer.

86. The computer system of claim 82 wherein the data control server computer is programmed to provide rewards to the consumer based on the quality of consumer data provided by the consumer.

87. The computer system of claim 82 wherein the data control server computer is programmed to provide rewards to the consumer based on the permission to use the consumer data provided by the consumer.

88. The computer system of claim 82 wherein the rewards comprise reward points added to a reward account associated with the user.
